(19) United States
(12) Patent Application Publication
(10) Pub. No.: US 2025/0273899 A1
(43) Pub. Date: Aug. 28, 2025

(54) WIRE HARNESS MANUFACTURING METHOD AND WIRE HARNESS

(71) Applicant: YAZAKI CORPORATION, Tokyo (JP)

(72) Inventor: Syuji Kimura, Makinohara-shi (JP)

(21) Appl. No.: 19/181,345

(22) Filed: Apr. 17, 2025

Related U.S. Application Data
(63) Continuation of application No. PCT/JP2024/004120, filed on Feb. 7, 2024.

(30) Foreign Application Priority Data
Mar. 8, 2023 (JP) 2023-035466

(51) Int. Cl. H01R 13/52; H01R 13/506; H01R 43/20

(52) U.S. Cl. CPC H01R 13/5213; H01R 13/506; H01R 43/20

(57) ABSTRACT

A wire harness manufacturing method includes a first welding step in which an electric wire connection portion of a first terminal accommodated in a first terminal accommodation groove and a core wire exposed portion are welded, a second welding step in which the electric wire connection portion of a second terminal accommodated in a second terminal accommodation groove and the core wire exposed portion are welded, a first cover assembling step in which a first cover is assembled to a first housing, and a second cover assembling step in which a second cover is assembled to a second housing so as to close the second terminal accommodation groove. Thereafter, in a connector forming step, the first housing and the second housing are stacked and assembled to each other in a height direction to form a connector to be fitted to a mating connector.

### CROSS-REFERENCE TO RELATED APPLICATION(S)

This application is a continuation application of International Application No. PCT/JP2024/004120 filed on Feb. 7, 2024 which claims the benefit of priority from Japanese Patent Application No. 2023-035466 filed on Mar. 8, 2023 and designating the U.S., the entire contents of which are incorporated herein by reference.

### BACKGROUND OF THE INVENTION

### 1. Field of the Invention

The present invention relates to a wire harness manufacturing method and a wire harness.

### 2. Description of the Related Art

In the related art, as a wire harness manufacturing method and a wire harness, for example, as described in JP 08-008 028 A, there is known a method in which an electric wire from which an insulating sheath is peeled and a connector terminal are placed in an electric wire reception groove, an electric wire clamping plate is placed on the electric wire, the electric wire is clamped by a conductive metal plate embedded in an electric wire holding groove provided in the electric wire clamping plate, and then the conductive metal plate is irradiated with laser light through a welding hole to weld the conductive metal plate and the electric wire.

In the conventional wire harness manufacturing method and wire harness, since the connector is a welding connection dedicated product, for example, it is necessary to newly install connectors for a male terminal and a female terminal, and there is room for improvement in terms of versatility of the connector and the terminal.

### SUMMARY OF THE INVENTION

An object of the present invention is to provide a wire harness manufacturing method and a wire harness capable of improving versatility of a connector and a terminal.

In order to achieve the above mentioned object, a wire harness manufacturing method according to one aspect of the present invention includes a first accommodating step of accommodating a first terminal in a first terminal accommodation groove formed in a first housing; a first welding step of bringing a core wire exposed portion provided at an end of a first electric wire into contact with an electric wire connection portion of the first terminal accommodated in the first terminal accommodation groove of the first housing and welding the electric wire connection portion and the core wire exposed portion after the first accommodating step; a first cover assembling step of assembling a first cover to the first housing so as to close the first terminal accommodation groove after the first welding step; a second accommodating step of accommodating a second terminal in a second terminal accommodation groove formed in a second housing; a second welding step of bringing a core wire exposed portion provided at an end of a second electric wire into contact with an electric wire connection portion of the second terminal accommodated in the second terminal accommodation groove of the second housing and welding the electric wire connection portion and the core wire exposed portion after the second accommodating step; a second cover assembling step of assembling a second cover to the second housing so as to close the second terminal accommodation groove after the second welding step; and a connector forming step of forming a connector to be fitted to a mating connector by stacking the first housing and the second housing in a height direction intersecting an extension direction of the first electric wire and the second electric wire and assembling the first housing and the second housing to each other after the first cover assembling step and the second cover assembling step, and wherein the second housing includes a pair of housing locking claws that is formed so as to protrude from an end portion of the second housing on a removal direction side toward a bottom direction side, which is one of the height directions, the first housing includes a pair of locked portions that is formed on both sides of the first housing in the width direction, and locks a pair of cover locking claws provided on the first cover in a state where the first cover is assembled to the first housing, and the pair of housing locking claws is locked to the pair of locked portions in a state where the first housing to which the first cover is assembled and the second housing are stacked and assembled to each other in the height direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire harness manufactured by a wire harness manufacturing method according to an embodiment;

FIG. 2 is a perspective view of a connector applied to the wire harness according to the embodiment;

FIG. 3 is an exploded perspective view of the connector illustrated in FIG. 2;

FIG. 4 is a plan view of a terminal applied to the wire harness according to the embodiment;

FIG. 5 is a partial cross-sectional view of a connector illustrating a positional relationship between a terminal accommodated in a terminal accommodation groove and a housing;

FIG. 6 is a flowchart illustrating an example of the wire harness manufacturing method according to the embodiment;

FIG. 7 is a view schematically illustrating a first accommodating step of the wire harness manufacturing method according to the embodiment;

FIG. 8 is a view schematically illustrating a first welding step of the wire harness manufacturing method according to the embodiment;

FIG. 9 is a view schematically illustrating a first cover assembling step of the wire harness manufacturing method according to the embodiment; and

FIG. 10 is a view schematically illustrating a second accommodating step of the wire harness manufacturing method according to the embodiment.

### DETAILED DESCRIPTION OF THE PREFERRED EMBODIMENTS

Hereinafter, an embodiment according to the present invention will be described in detail with reference to the drawings. Note that the present invention is not limited by the embodiment. In addition, constituent elements in the following embodiments include those that can be easily assumed by those skilled in the art or those that are substantially identical, and various omissions, substitutions, and changes can be made without departing from the gist of the invention.

### Embodiment

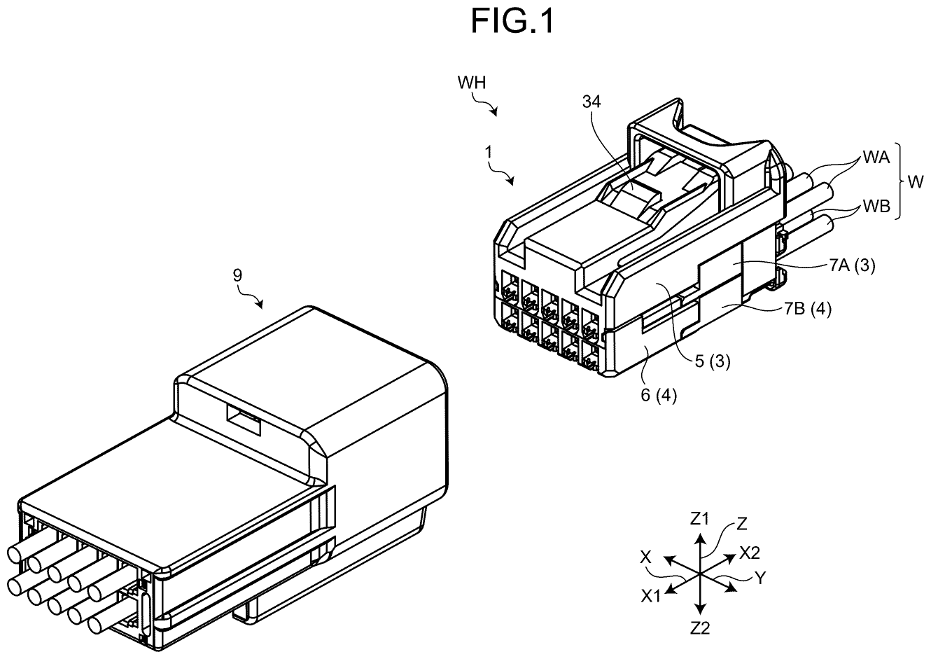

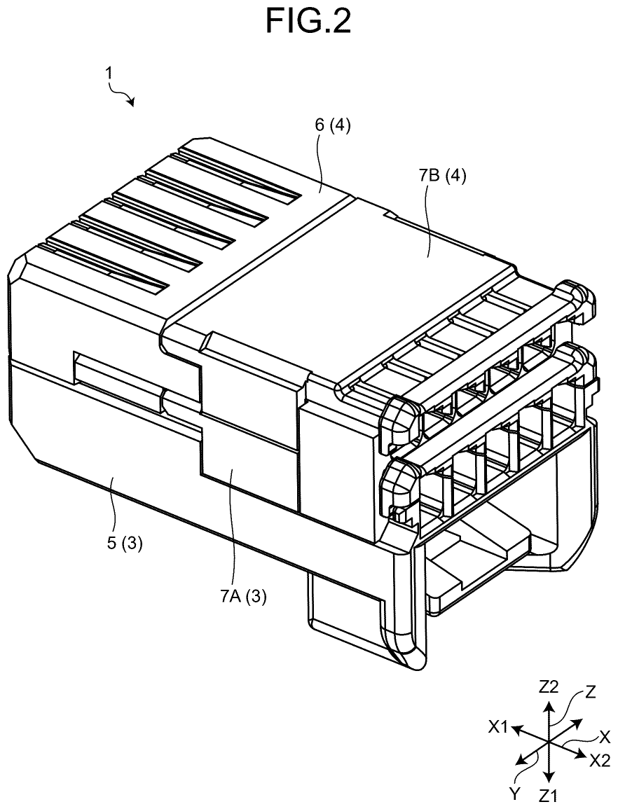

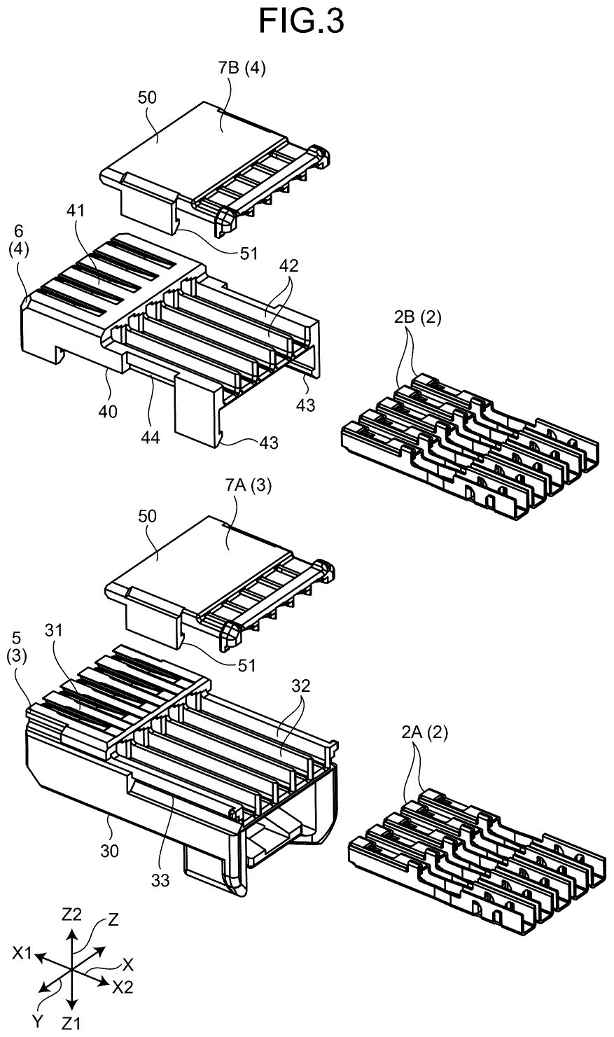

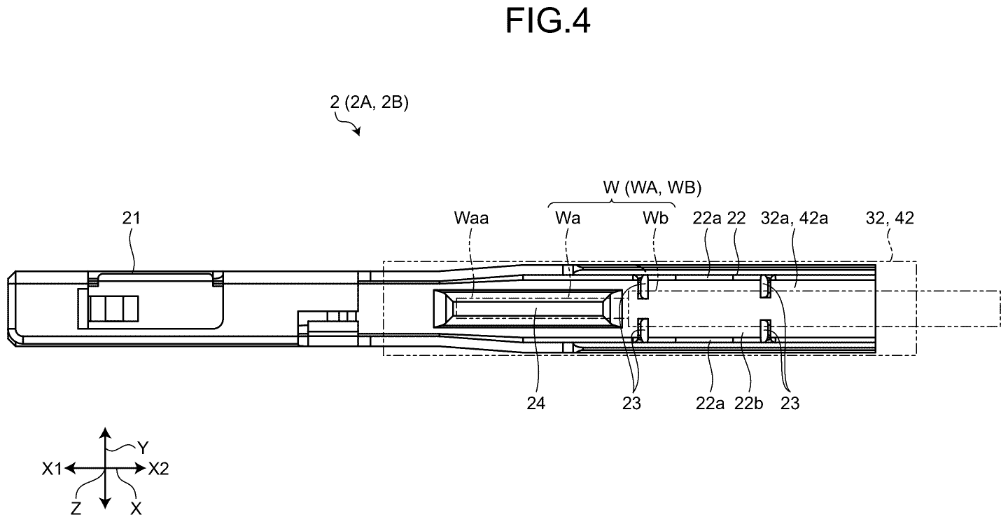

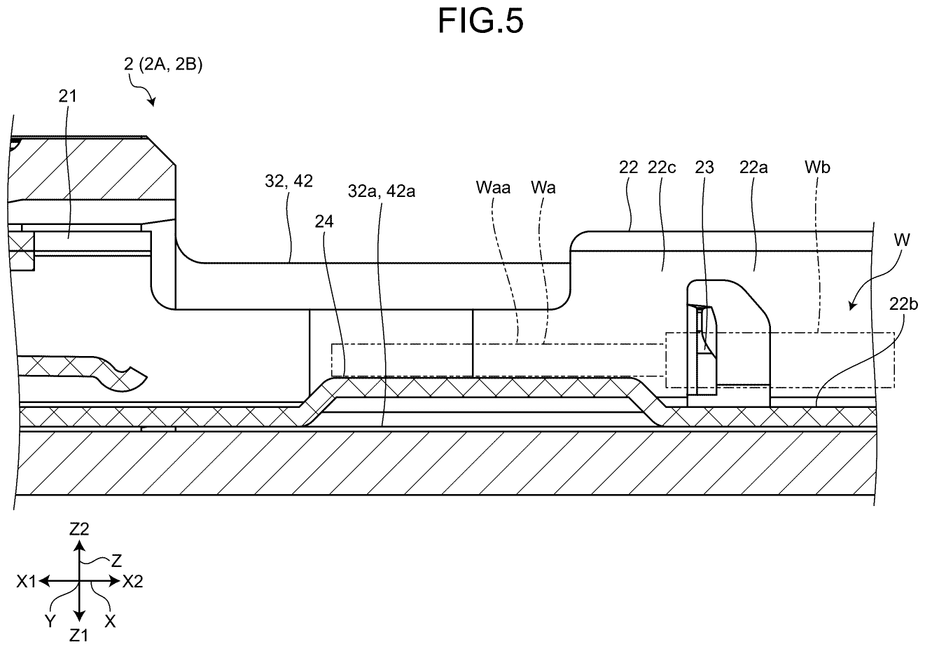

The wire harness manufacturing method according to the present embodiment manufactures a wire harness WH illustrated in FIG. 1. Hereinafter, first, the basic configuration of the wire harness WH illustrated in FIGS. 1 to 5 will be described, and then the wire harness manufacturing method will be described in detail. FIG. 1 is a perspective view of a wire harness manufactured by a wire harness manufacturing method according to an embodiment. FIG. 2 is a perspective view of a connector applied to the wire harness according to the embodiment, and FIG. 3 is an exploded perspective view of the connector. FIG. 4 is a plan view of a terminal applied to the wire harness according to the embodiment. FIG. 5 is a partial cross-sectional view of a connector illustrating a positional relationship between a terminal accommodated in a terminal accommodation groove of a housing and the housing. Note that a connector 1 illustrated in FIGS. 2, 3, 5, and 7 to 10 is illustrated upside down in the vertical direction in the drawing with respect to a connector 1 illustrated in FIG. 1.

In the following description, for convenience, among the X direction, the Y direction, and the Z direction in the drawings, the X direction is referred to as an “axial direction X”, the Y direction is referred to as a “width direction Y”, and the Z direction is referred to as a “height direction Z”. The axial direction X, the width direction Y, and the height direction Z are orthogonal to each other. The axial direction X corresponds to a direction along the extension direction of an electric wire W. The width direction Y and the height direction Z are included in a direction orthogonal to the axial direction X. Specifically, in the axial direction X, one is referred to as an “insertion direction X1” and the other is referred to as a “removal direction X2”, and in the height direction Z, one is referred to as a “bottom direction Z1” and the other is referred to as an “opening direction Z2”. Each direction used in the following description will be described as a direction in a state where the respective units are assembled to each other unless otherwise specified.

The wire harness WH illustrated in FIG. 1 and the like is configured such that, for example, a plurality of electric wires W used for power supply and signal communication are bundled to form a collective component for connection between devices mounted on a vehicle, and the plurality of electric wires W is connected to the devices by the connector 1. The wire harness WH of the present embodiment includes the electric wire W and the connector 1 that accommodates a terminal 2 and enables laser welding between an electric wire connection portion 22 and a core wire exposed portion Waa in a state where the core wire exposed portion Waa of the electric wire W is in contact with the electric wire connection portion 22 of the terminal 2. The wire harness WH may further include various components such as a grommet, an electrical connection box, a fixture, and a connector.

As illustrated in FIG. 4, the electric wire W includes a conductive core wire Wa extending along the axial direction X and an insulating sheath Wb having an insulating property and covering the outer side of the core wire Wa. The electric wire W is an insulation electric wire in which the core wire Wa is covered with an insulating sheath Wb. In the electric wire W, the insulating sheath Wb is peeled off at least one end in the axial direction X, and the core wire Wa is exposed from the end of the insulating sheath Wb to form the core wire exposed portion Waa. Note that, for convenience, in the electric wire W of the present embodiment, a wire applied to a first assembly 3 to be described later may be referred to as a “first electric wire WA”, and a wire applied to a second assembly 4 to be described later may be referred to as a “second electric wire WB”. In addition, in a case where it is not particularly necessary to distinguish between the two, the wire may be simply referred to as an “electric wire W”.

The core wire Wa is, for example, a bundle of a plurality of strands (not illustrated) of a conductive metal such as aluminum, an aluminum alloy, copper, or a copper alloy. The cross-sectional shape of the core wire exposed portion Waa in the direction orthogonal to the axial direction X is circular as in the core wire Wa. The core wire Wa may be a stranded core wire obtained by twisting a plurality of strands.

The insulating sheath Wb is formed by extrusion molding, for example, an insulating resin material (polypropylene (PP), polyvinyl chloride (PVC), cross-linked polyethylene (PE), or the like, which is appropriately selected in consideration of abrasion resistance, chemical resistance, heat resistance, and the like). The cross-sectional shape of the insulating sheath Wb in the direction orthogonal to the axial direction X is formed in a substantially annular shape along the circumferential direction.

The terminal 2 is formed of a conductive metal such as copper or a copper alloy, and is not a so-called crimp terminal but a so-called laser welding terminal formed so as to be laser-weldable between the terminal 2 and the core wire exposed portion Waa of the electric wire W. The terminal 2 is a female terminal, and is electrically connected to a mating terminal (not illustrated) which is a male terminal by fitting the connector 1 and a mating connector 9 as illustrated in FIG. 1. Note that, for convenience, in the terminal 2 of the present embodiment, a terminal applied to a first assembly 3 to be described later may be referred to as a “first terminal 2A”, a terminal applied to a second assembly 4 to be described later may be referred to as a “second terminal 2B”, and the terminal may be simply referred to as a “terminal 2” in a case where it is not particularly necessary to distinguish between the two.

The terminal 2 includes a terminal connection portion 21 and an electric wire connection portion 22.

The terminal connection portion 21 is formed on the insertion direction X1 side of the terminal 2. The terminal connection portion 21 is a portion to which the mating terminal of the mating connector 9 is connected by fitting the connector 1 and the mating connector 9 in a state where the electric wire W is connected to the terminal 2 accommodated in the connector 1.

The electric wire connection portion 22 is formed on the removal direction X2 side of the terminal 2. The electric wire connection portion 22 is a portion where the core wire exposed portion Waa provided at the end of the electric wire W is welded in a state where the terminal 2 is accommodated in the connector 1. The electric wire connection portion 22 has a substantially U-shaped cross section when viewed in the axial direction X. The electric wire connection portion 22 includes a pair of side walls 22a formed to face each other in the width direction Y, and a bottom wall 22b that couples the pair of side walls 22a on the bottom direction Z1 side in a state where the terminal 2 is accommodated in the connector 1.

As illustrated in FIGS. 4 and 5, the pair of side walls 22a includes a pair of sheath fixing portions 23 formed to protrude from each side wall 22a toward an electric wire accommodation space 22c. The pair of sheath fixing portions 23 sandwiches the insulating sheath Wb of the electric wire W from both sides in the width direction Y to fix the electric wire W and the terminal 2 in a state where the core wire exposed portion Waa of the electric wire W is in contact with the electric wire connection portion 22 of the terminal 2. Therefore, the width of the pair of sheath fixing portions 23 in the width direction Y is shorter than the width of the pair of side walls 22a in the width direction Y. In addition, the pair of sheath fixing portions 23 is formed on the insertion direction X1 side of the electric wire connection portion 22 and on the removal direction X2 side opposite to the insertion direction X1. As illustrated in FIG. 5, each of the sheath fixing portions 23 is formed such that the plate thickness of the end portion on the opening direction Z2 side decreases toward the distal end in the opening direction Z2.

As illustrated in FIG. 5, the bottom wall 22b has a welding portion 24 formed inside the electric wire connection portion 22 so as to protrude toward the electric wire accommodation space 22c formed by the bottom wall 22b and the pair of side walls 22a. The welding portion 24 is formed so as to come into contact with the core wire exposed portion Waa in a state where the electric wire W is accommodated in the electric wire connection portion 22 and the insulating sheath Wb of the electric wire W is fixed to the sheath fixing portion 23. That is, the welding portion 24 is formed higher in the height direction Z than the sheath fixing portion 23 side of the bottom wall 22b. In addition, the welding portion 24 is formed at a position separated from a first housing 5 and a second housing 6 without coming into contact with the first housing 5 and the second housing 6 in a state where the first terminal 2A is accommodated in the first housing 5 and in a state where the second terminal 2B is accommodated in the second housing 6.

Next, the first assembly 3 and the second assembly 4 constituting the connector 1 will be described.

The first assembly 3 includes the first terminal 2A having an electric wire connection portion 22 to which the core wire exposed portion Waa of the first electric wire WA is welded, the first housing 5 in which a first terminal accommodation groove 32 that accommodates the first terminal 2A is formed, and a first cover 7A assembled to the first housing 5 so as to close the first terminal accommodation groove 32 in a state where the first terminal 2A is accommodated in the first terminal accommodation groove 32.

The first housing 5 includes a housing main body 30, a terminal holding portion 31 formed on the insertion direction X1 side of the housing main body 30, a plurality of first terminal accommodation grooves 32 formed to open on the opening direction Z2 side of the housing main body 30, a pair of locked portions 33 formed on both sides of the housing main body 30 in the width direction Y, and a mating connector locking portion 34 formed on the bottom direction Z1 side of the housing main body 30.

The terminal holding portion 31 is a portion that accommodates and holds the terminal connection portion 21 of the first terminal 2A in a state where the first terminal 2A is accommodated in the first terminal accommodation groove 32.

The first terminal accommodation groove 32 is a portion that accommodates the first terminal 2A. The first terminal accommodation groove 32 extends in the axial direction X, and has a U-shaped cross section when viewed in the axial direction X. The first terminal accommodation groove 32 not only corresponds to a so-called laser welding terminal, but also corresponds to a crimp terminal.

The pair of locked portions 33 is formed the first terminal accommodation groove 32 of the housing main body 30 and is a portion that locks the second housing 6 and the first cover 7A. Each of the locked portions 33 locks the pair of cover locking claws 51 provided on the first cover 7A in a state where the first cover 7A is assembled to the first housing 5 so as to close the first terminal accommodation groove 32, and locks a housing locking claws 43 provided on the second housing 6 in a state where the first housing 5 and the second housing 6 are stacked and assembled to each other in the height direction Z.

The mating connector locking portion 34 is a portion that locks the mating connector 9 when the connector 1 is fitted to the mating connector 9.

The second assembly 4 includes the second terminal 2B having the electric wire connection portion 22 to which the core wire exposed portion Waa of the second electric wire WB is welded, the second housing 6 in which the second terminal accommodation groove 42 that accommodates the second terminal 2B is formed, and a second cover 7B assembled to the second housing 6 so as to close the second terminal accommodation groove 42 in a state where the second terminal 2B is accommodated in the second terminal accommodation groove 42.

The second housing 6 includes a housing main body 40, a terminal holding portion 41 formed on the insertion direction X1 side of the housing main body 40, a plurality of second terminal accommodation grooves 42 formed so as to open on the opening direction Z2 side of the housing main body 40, a pair of housing locking claws 43 formed so as to protrude from an end portion of the housing main body 40 on the removal direction X2 side toward the bottom direction Z1, and a pair of locked portions 44 formed on both sides in the width direction Y of the housing main body 40.

The terminal holding portion 41 is a portion that accommodates and holds the terminal connection portion 21 of the second terminal 2B in a state where the second terminal 2B is accommodated in a second terminal accommodation groove 42.

The second terminal accommodation groove 42 is a portion that accommodates the second terminal 2B. The second terminal accommodation groove 42 extends in the axial direction X, and has a U-shaped cross section when viewed in the axial direction X. The second terminal accommodation groove 42 corresponds to a so-called laser welding terminal, but is also formed to correspond to a crimp terminal. The second terminal accommodation groove 42 has an identical shape as the first terminal accommodation groove 32.

The pair of housing locking claws 43 is a portion that locks the second housing 6 and the first housing 5 to each other. Each of the housing locking claws 43 is locked to the locked portion 33 of the first housing 5 in a state where the first housing 5 and the second housing 6 are stacked and assembled to each other in the height direction Z.

The pair of locked portions 44 is portions that locks the second cover 7B. Each of the locked portions 44 locks the pair of cover locking claws 51 provided on the second cover 7B in a state where the second cover 7B is assembled to the second housing 6 so as to close the second terminal accommodation groove 42.

The first cover 7A and the second cover 7B have an identical shape, and each of the first cover 7A and the second cover 7B includes a cover main body 50, a cover locking claw 51, and a cover restriction portion 52.

The cover locking claw 51 is a portion formed to protrude from both ends of the cover main body 50 in the width direction Y toward the bottom direction Z1. The cover locking claw 51 of the first cover 7A is locked to the locked portion 33 of the first housing 5 in a state where the first cover 7A is assembled to the first housing 5. The cover locking claw 51 of the second cover 7B is locked to the locked portion 44 of the second housing 6 in a state where the second cover 7B is assembled to the second housing 6.

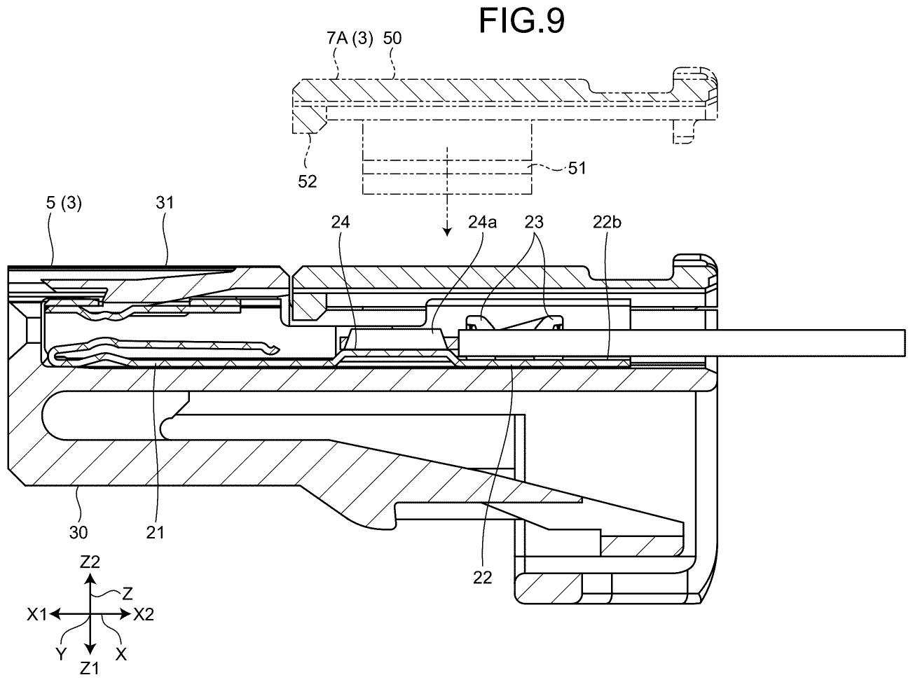

As illustrated in FIG. 9, the cover restriction portion 52 is a portion formed so as to protrude from an end portion of the cover main body 50 in the insertion direction X1 toward the bottom direction Z1. In a state where the first cover 7A is assembled to the first housing 5, the cover restriction portion 52 of the first cover 7A contacts the end portion of the terminal connection portion 21 of the first terminal 2A in the removal direction X2 to restrict the movement of the first terminal 2A toward the removal direction X2. In a state where the second cover 7B is assembled to the second housing 6, the cover restriction portion 52 of the second cover 7B contacts the end portion of the terminal connection portion 21 of the second terminal 2B on the removal direction X2 side to restrict the movement of the second terminal 2B toward the removal direction X2.

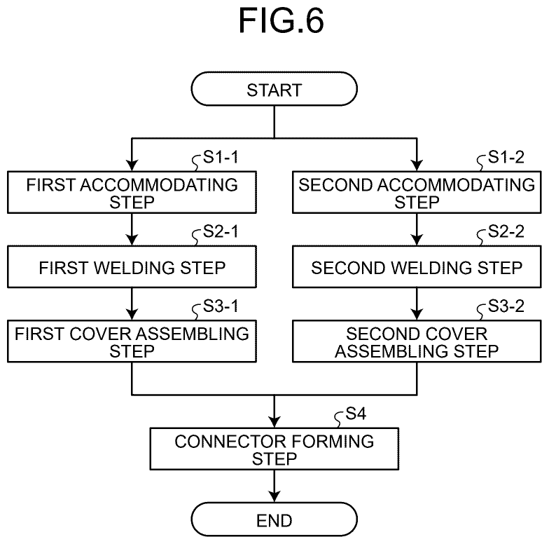

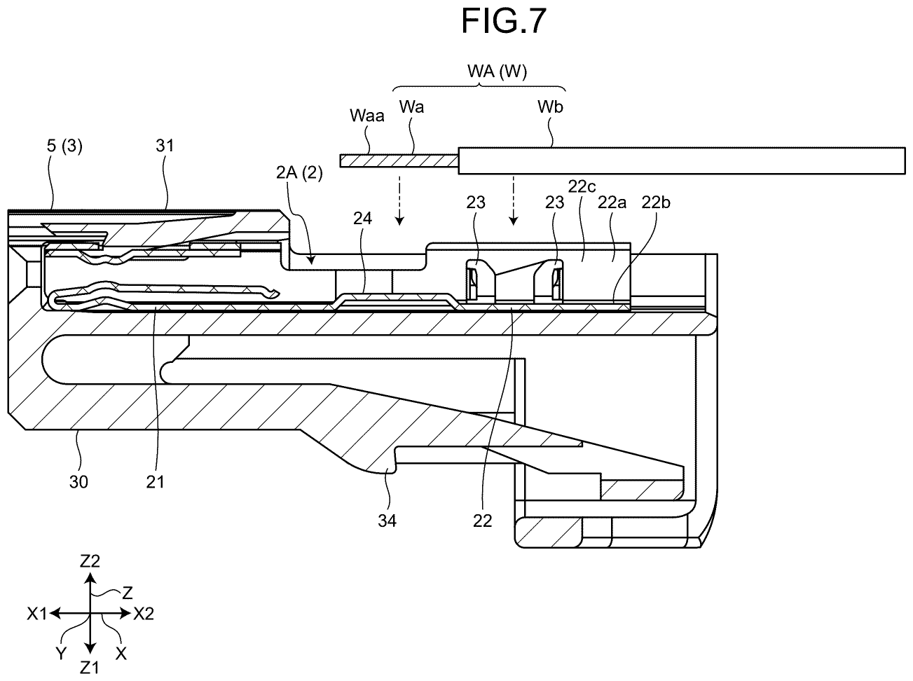

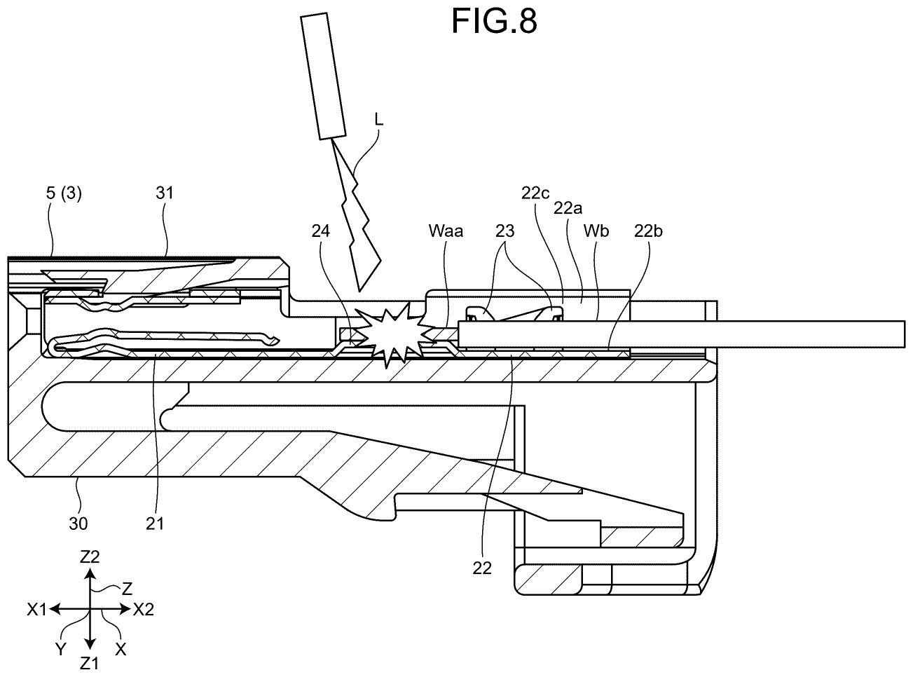

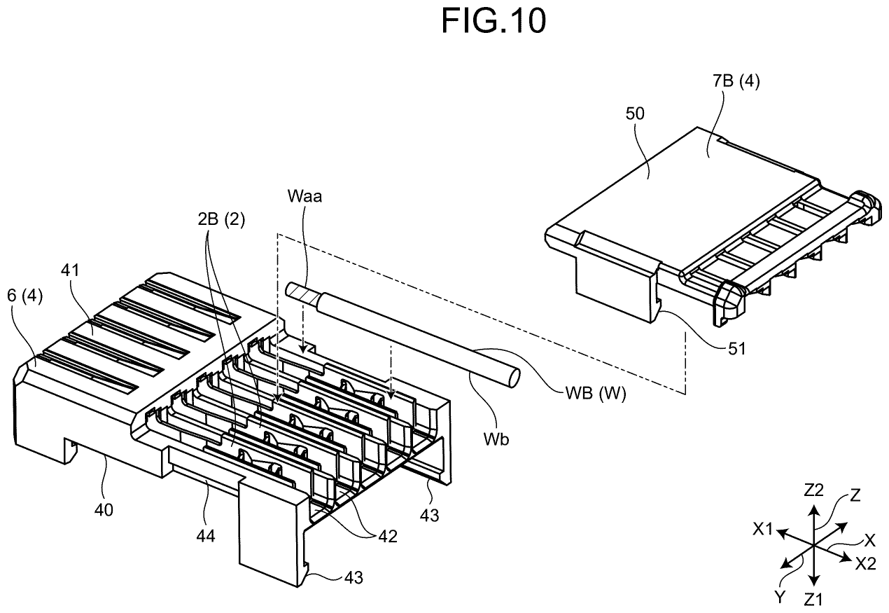

Next, a wire harness manufacturing method according to an embodiment will be described with reference to FIGS. 6 to 10. FIG. 6 is a flowchart illustrating an example of the wire harness manufacturing method. FIG. 7 is a view schematically illustrating a first accommodating step of the wire harness manufacturing method. FIG. 8 is a view schematically illustrating a first welding step of the wire harness manufacturing method. FIG. 9 is a view schematically illustrating a first cover assembling step of the wire harness manufacturing method. FIG. 10 is a view schematically illustrating a second accommodating step of the wire harness manufacturing method. In the following description, while description is made based on the flowchart of FIG. 6, other drawings are appropriately referred to. The method of manufacturing the wire harness WH described below may be manually performed by an operator using various devices, equipment, jigs, and the like, or may be automatically performed by various manufacturing devices.

The method of manufacturing the wire harness WH of the present embodiment includes a first accommodating step (step S1-1), a first welding step (step S2-1), a first cover assembling step (step S3-1), a second accommodating step (S1-2), a second welding step (S2-2), a second cover assembling step (S3-2), and a connector forming step (S4). It is assumed that the core wire exposed portion Waa is provided at the end of the electric wire W before the first accommodating step and the second accommodating step, the first terminal 2A is accommodated in the first terminal accommodation groove 32 of the first housing 5, and the second terminal 2B is accommodated in the second terminal accommodation groove 42 of the second housing 6.

The first accommodating step (step S1-1) is a step of accommodating the first terminal 2A in the first terminal accommodation groove 32 formed in the first housing 5. Specifically, the operator uses a device or a jig (not illustrated) to accommodate the plurality of first terminals 2A in each of the first terminal accommodation grooves 32 along the insertion direction X1 such that the terminal connection portion 21 of the first terminal 2A is hidden inside the terminal holding portion 31 of the first housing 5.

The first welding step (step S2-1) is a step of welding the electric wire connection portion 22 and the core wire exposed portion Waa by bringing the core wire exposed portion Waa provided at the end of the first electric wire WA into contact with the electric wire connection portion 22 of the first terminal 2A accommodated in the first terminal accommodation groove 32 of the first housing 5 after the first accommodating step (step S1-1). Specifically, as illustrated in FIG. 7, the operator assembles the first electric wire WA to the first terminal 2A accommodated in the first terminal accommodation groove 32 from the opening direction 22 using a device or a jig (not illustrated). At this time, in the first electric wire WA, the insulating sheath Wb in the vicinity of the core wire exposed portion Waa is sandwiched by each of the two pairs of sheath fixing portions 23 so that the core wire exposed portion Waa comes into contact with the welding portion 24 of the first terminal 2A. Subsequently, the operator irradiates the core wire exposed portion Waa with a laser light L from the opening direction Z2 using a device (not illustrated) to laser-weld the core wire exposed portion Waa and the welding portion 24. As a result, a welding portion 24a is formed on the welding portion 24.

The first cover assembling step (step S3-1) is a step of assembling the first cover 7A to the first housing 5 so as to close the first terminal accommodation groove 32 after the first welding step (step S2-1). As illustrated in FIG. 9, the operator assembles the first cover 7A to the first housing 5 so as to close the first terminal accommodation groove 32 by locking the cover locking claw 51 of the first cover 7A to the mating connector locking portion 34 of the first housing 5 using a device or a jig (not illustrated) or manually.

The second accommodating step (step S1-2) is a step of accommodating the second terminal 2B in the second terminal accommodation groove 42 formed in the second housing 6. Specifically, the operator uses a device or a jig (not illustrated) to accommodate each of the plurality of second terminals 2B in each of the second terminal accommodation grooves 42 along the insertion direction X1 such that the terminal connection portion 21 of the second terminal 2B is hidden inside the terminal holding portion 41 of the second housing 6.

The second welding step (step S2-2) is a step of welding the electric wire connection portion 22 and the core wire exposed portion Waa by bringing the core wire exposed portion Waa provided at the end of the second electric wire WB into contact with the electric wire connection portion 22 of the second terminal 2B accommodated in the second terminal accommodation groove 42 of the second housing 6 after the second accommodating step (step S1-2). Specifically, as illustrated in FIG. 10, the operator assembles the second electric wire WB to the second terminal 2B accommodated in the second terminal accommodation groove 42 from the opening direction Z2 using a device or a jig (not illustrated). At this time, in the second electric wire WB, the insulating sheath Wb in the vicinity of the core wire exposed portion Waa is sandwiched by each of the two pairs of sheath fixing portions 23 such that the core wire exposed portion Waa comes into contact with the welding portion 24 of the second terminal 2B. Subsequently, the operator irradiates the core wire exposed portion Waa with a laser light L from the opening direction Z2 using a device (not illustrated) to laser-weld the core wire exposed portion Waa and the welding portion 24. As a result, a welding portion 24a is formed on the welding portion 24.

The second cover assembling step (step S3-2) is a step of assembling the second cover 7B to the second housing 6 so as to close the second terminal accommodation groove 42 after the second welding step (step S2-2). As illustrated in FIG. 10, the operator assembles the second cover 7B to the second housing 6 so as to close the second terminal accommodation groove 42 by locking the cover locking claw 51 of the second cover 7B to the locked portion 44 of the second housing 6 using a device or a jig (not illustrated) or manually.

The connector forming step (step S4) is a step of forming the connector 1 to be fitted to the mating connector 9 by stacking the first housing 5 and the second housing 6 in the height direction Z intersecting the extension direction of the first electric wire WA and the second electric wire WB and assembling them to each other after the first cover assembling step (step S3-1) and the second cover assembling step (step S3-2). In the connector forming step (step S4), the wire harness manufacturing method is terminated. As described above, the wire harness WH manufactured by the wire harness manufacturing method has a shape in which the connector 1 can be fitted to the mating connector 9 as a whole in a state where the first assembly 3 and the second assembly 4 are assembled to each other.

In the wire harness manufacturing method described above, the first terminal 2A is accommodated in the first housing 5 in the first accommodating step (S1-1), and the second terminal 2B is accommodated in the second housing 6 in the second accommodating step (S1-2). After the first accommodating step (S1-1) and the second accommodating step (S1-2), in the first welding step (S2-1), the core wire exposed portion Waa of the first electric wire WA is brought into contact with the electric wire connection portion 22 of the first terminal 2A accommodated in the first terminal accommodation groove 32 of the first housing 5 to weld the electric wire connection portion 22 and the core wire exposed portion Waa, and in the second welding step (S2-2), the core wire exposed portion Waa of the second electric wire WB is brought into contact with the electric wire connection portion 22 of the second terminal 2B accommodated in the second terminal accommodation groove 42 of the second housing 6 to weld the electric wire connection portion 22 and the core wire exposed portion Waa. After the first welding step (S2-1) and the second welding step (S2-2), the first cover 7A is assembled to the first housing 5 so as to close the first terminal accommodation groove 32 in the first cover assembling step (S3-1), and the second cover 7B is assembled to the second housing 6 so as to close the second terminal accommodation groove 42 in the second cover assembling step (S3-2). After the first cover assembling step (S3-1) and the second cover assembling step (S3-2), in the connector forming step (S4), the first housing 5 and the second housing 6 are stacked and assembled to each other in the height direction Z to form the connector 1 to be fitted to the mating connector 9.

In the wire harness manufacturing method, a housing having fitting compatibility with the mass production connector can be applied in a manufacturing step of laser-welding the laser welding terminal and the electric wire in a state where the laser welding terminal is assembled to the housing of the connector by the above step. As a result, the wire harness manufacturing method can improve versatility of the connector and the terminal without forming a dedicated product suitable for the above manufacturing step.

The wire harness WH manufactured by the above wire harness manufacturing method includes the first assembly 3 and the second assembly 4. The first assembly 3 includes the first housing 5 and the first cover 7A assembled to the first housing 5 so as to close the first terminal accommodation groove 32 in a state where the first terminal 2A is accommodated in the first terminal accommodation groove 32. The second assembly 4 includes the second housing 6 and the second cover 7B assembled to the second housing 6 so as to close the second terminal accommodation groove 42 in a state where the second terminal 2B is accommodated in the second terminal accommodation groove 42. The first assembly 3 and the second assembly 4 constitute the connector 1 to be fitted to the mating connector 9 in a state where the first housing 5 and the second housing 6 are stacked in the height direction Z and assembled to each other.

With the above configuration, the wire harness WH can be manufactured by a manufacturing step of laser welding the laser welding terminal and the electric wire in a state where the laser welding terminal is assembled to the housing of the connector while applying the housing having fitting compatibility with the mass production connector. As a result, the wire harness WH can improve the versatility of the connector and the terminal without forming a dedicated product suitable for the above manufacturing step.

In addition, in the wire harness manufacturing method and the wire harness WH, since the female terminal connector 1 has fitting compatibility with the mass production connector, it is only required to replace the connector 1, and it is not necessary to change the mating connector 9, so that the component cost due to the change of the connector can be reduced. In addition, in the wire harness manufacturing method and the wire harness WH, since the first terminal accommodation groove 32 and the second terminal accommodation groove 42 of the connector 1 can have the identical specification as the terminal accommodation groove of the mass production connector, the crimp terminal applied to the mass production connector can be attached to the connector 1. Thus, in the wire harness manufacturing method and the wire harness WH, replacement from the laser welding terminal to the crimp terminal can be easily performed at the time of maintenance of the wire harness WH. For example, when there is no laser welding equipment or when welding conditions are not met due to a difference in electric wire size, it is possible to crimp the electric wire W to a crimp terminal applied to the mass production connector and attach the crimp terminal to the connector 1.

In the wire harness manufacturing method and the wire harness WH, the first assembly 3 and the second assembly 4 constitute the connector 1 fitted to the mating connector 9 in a state where the first housing 5 and the second housing 6 are stacked in the height direction Z and assembled to each other. This makes it possible to realize a connector in which so-called cavities are formed in two stages in the height direction Z.

In the wire harness manufacturing method and the wire harness WH, the first terminal accommodation groove 32 and the second terminal accommodation groove 42 are closed by the first cover 7A and the second cover 7B configured separately from the first housing 5 and the second housing 6. Thus, the wire harness manufacturing method and the wire harness WH can protect the welding portion 24a of each of the first terminal 2A and the second terminal 2B.

In the wire harness manufacturing method and the wire harness WH, the first cover 7A and the second cover 7B have an identical shape, and the first terminal 2A and the second terminal 2B have an identical shape. As a result, the first cover 7A and the second cover 7B can be made common, and the first terminal 2A and the second terminal 2B can be made common, and the component cost can be reduced.

In addition, the first cover 7A includes the cover restriction portion (first restriction portion) 52 that restricts the movement of the first terminal 2A in the removal direction X2 opposite to the insertion direction X1 in a state where the first cover 7A is accommodated in the first terminal accommodation groove 32. The second cover 7B includes a cover restriction portion (second restriction portion) 52 that restricts the movement of the second terminal 2B in the removal direction X2 opposite to the insertion direction X1 in a state where the second cover 7B is accommodated in the second terminal accommodation groove 42. Accordingly, in the wire harness manufacturing method and the wire harness WH, the terminal retaining of the first terminal 2A with respect to the first housing 5 and the terminal retaining of the second terminal 2B with respect to the second housing 6 can be easily shared.

In addition, each of the first terminal 2A and the second terminal 2B has a pair of sheath fixing portions 23 formed to protrude from the side wall 22a toward the electric wire accommodation space 22c. As a result, when the electric wire W provided with the core wire exposed portion Waa at the end is assembled to the electric wire connection portion 22, the electric wire W can be easily fixed to the terminal 2 only by pushing the electric wire W to the electric wire connection portion 22 from the opening direction Z2 toward the bottom direction Z1.

In addition, each of the first terminal 2A and the second terminal 2B has the welding portion 24 recessed toward the electric wire accommodation space 22c so as to be separated from a groove bottom portion 32a of the first terminal accommodation groove 32 and a groove bottom portion 42a of the second terminal accommodation groove 42 in the height direction Z. As a result, in the first welding step (step S2-1) and the second welding step (step S2-2), heat generated when the core wire exposed portion Waa and the welding portion 24 are laser-welded can be made difficult to transmit to the first housing 5 and the second housing 6.

In the wire harness manufacturing method of the above embodiment, the work is performed in the order of the first accommodating step (step S1-1), the first welding step (step S2-1), the first cover assembling step (step S3-1), the second accommodating step (step S1-2), the second welding step (step S2-2), and the second cover assembling step (step S3-2), but the present invention is not limited thereto. As the wire harness manufacturing method according to the modification of the above embodiment, the work may be performed in the order of the second accommodating step (step S1-2), the second welding step (step S2-2), the second cover assembling step (step S3-2), the first accommodating step (step S1-1), the first welding step (step S2-1), and the first cover assembling step (step S3-1). In addition, the first accommodating step (step S1-1), the first welding step (step S2-1), and the first cover assembling step (step S3-1), and the second accommodating step (step S1-2), the second welding step (step S2-2), and the second cover assembling step (step S3-2) may be performed in parallel.

In the above embodiment, the first terminal accommodation groove 32 and the second terminal accommodation groove 42 are formed so as to be able to accommodate the terminal 2 having a shape suitable for laser welding, but the present invention is not limited thereto, and it is also possible to accommodate a crimp terminal crimped to the end of the electric wire W. For example, when repairing the laser-welded terminal 2, it is possible to repair using a crimp terminal. In this case, the connector corresponds to the mass production connector accommodated in each of the first terminal accommodation groove 32 and the second terminal accommodation groove 42.

Further, in the above embodiment, the connector 1 includes the first assembly 3 and the second assembly 4 stacked in the height direction Z, but is not limited thereto. For example, the connector 1 may include three or more assemblies.

In the above embodiment, the electric wire W is described separately as the “first electric wire WA” and the “second electric wire WB” for convenience, but the “first electric wire WA” and the “second electric wire WB” may be electric wires of the identical specification or electric wires of different specifications.

In the above embodiment, the terminal 2 is described separately as the “first terminal 2A” and the “second terminal 2B” for convenience, but the “first terminal 2A” and the “second terminal 2B” may be terminals having an identical shape and the identical specification, or may be terminals having different shapes and different specifications.

In the above embodiment, the description is made in which the connector 1 corresponds to the mass production connector and the rows of the terminal accommodation chambers 32 and 42 are disposed in the height direction Z, but the present invention is not limited thereto, and the terminal accommodation chambers 32 and 42 may be disposed in three or more rows in the height direction Z.

According to the wire harness manufacturing method and the wire harness of the present embodiment, it is possible to improve versatility of the connector and the terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness manufacturing method comprising:
a first accommodating step of accommodating a first terminal in a first terminal accommodation groove formed in a first housing;
a first welding step of bringing a core wire exposed portion provided at an end of a first electric wire into contact with an electric wire connection portion of the first terminal accommodated in the first terminal accommodation groove of the first housing and welding the electric wire connection portion and the core wire exposed portion after the first accommodating step;
a first cover assembling step of assembling a first cover to the first housing so as to close the first terminal accommodation groove after the first welding step;
a second accommodating step of accommodating a second terminal in a second terminal accommodation groove formed in a second housing;
a second welding step of bringing a core wire exposed portion provided at an end of a second electric wire into contact with an electric wire connection portion of the second terminal accommodated in the second terminal accommodation groove of the second housing and welding the electric wire connection portion and the core wire exposed portion after the second accommodating step;
a second cover assembling step of assembling a second cover to the second housing so as to close the second terminal accommodation groove after the second welding step; and
a connector forming step of forming a connector to be fitted to a mating connector by stacking the first housing and the second housing in a height direction intersecting an extension direction of the first electric wire and the second electric wire and assembling the first housing and the second housing to each other after the first cover assembling step and the second cover assembling step, and wherein
the second housing
includes a pair of housing locking claws that is formed so as to protrude from an end portion of the second housing on a removal direction side toward a bottom direction side, which is one of the height directions,
the first housing
includes a pair of locked portions that is formed on both sides of the first housing in the width direction, and locks a pair of cover locking claws provided on the first cover in a state where the first cover is assembled to the first housing, and
the pair of housing locking claws is locked to the pair of locked portions in a state where the first housing to which the first cover is assembled and the second housing are stacked and assembled to each other in the height direction.

2. The wire harness manufacturing method according to claim 1, wherein
the first cover and the second cover have an identical shape, wherein
the first terminal and the second terminal have an identical shape, and wherein
the first electric wire and the second electric wire have an identical shape.

3. The wire harness manufacturing method according to claim 1, wherein
the first cover includes
a first restriction portion that restricts a movement of the first terminal in a removal direction opposite to an insertion direction in a state where the first cover is assembled to the first housing, and wherein
the second cover includes
a second restriction portion that restricts a movement of the second terminal in a removal direction opposite to an insertion direction in a state where the second cover is assembled to the second housing.

4. The wire harness manufacturing method according to claim 2, wherein
the first cover includes
a first restriction portion that restricts a movement of the first terminal in a removal direction opposite to an insertion direction in a state where the first cover is assembled to the first housing, and wherein
the second cover includes
a second restriction portion that restricts a movement of the second terminal in a removal direction opposite to an insertion direction in a state where the second cover is assembled to the second housing.

5. A wire harness comprising:
a first electric wire and a second electric wire, each of the first electric wire and the second electric wire including a conductive core wire extending along an axial direction and an insulating sheath covering the core wire in a state where an end portion of the core wire is exposed as a core wire exposed portion;
a first assembly that includes a first terminal having an electric wire connection portion to which the core wire exposed portion of the first electric wire is welded, a first housing in which a first terminal accommodation groove that accommodates the first terminal is formed, and a first cover assembled to the first housing so as to close the first terminal accommodation groove in a state where the first terminal is accommodated in the first terminal accommodation groove; and
a second assembly that includes a second terminal having an electric wire connection portion to which the core wire exposed portion of the second electric wire is welded, a second housing in which a second terminal accommodation groove that accommodates the second terminal is formed, and a second cover assembled to the second housing so as to close the second terminal accommodation groove in a state where the second terminal is accommodated in the second terminal accommodation groove, wherein
the first assembly and the second assembly constitute a connector to be fitted to a mating connector in a state where the first housing and the second housing are stacked in a height direction intersecting an extension direction of the first electric wire and the second electric wire and assembled to each other, and wherein
the second housing
includes a pair of housing locking claws that is formed so as to protrude from an end portion of the second housing on a removal direction side toward a bottom direction side, which is one of the height directions,
the first housing
includes a pair of locked portions that is formed on both sides of the first housing in the width direction, and locks a pair of cover locking claws provided on the first cover 7A in a state where the first cover is assembled to the first housing, and
the pair of housing locking claws is locked to the pair of locked portions in a state where the first housing to which the first cover 7A is assembled and the second housing are stacked and assembled to each other in the height direction.
